(19) United States
(12) Patent Application Publication
(10) Pub. No.: US 2007/0097253 A1
(43) Pub. Date: May 3, 2007

(54) Optical system having multiple curvature lens and manufacturing method thereof

(75) Inventors: Yeon Kyung Woo, Seoul (KR); Ho Seop Jeong, Sungnam (KR); Jun Ho Mun, Hwasung (KR); Ji Young An, Suwon (KR); Hwa Hun Chin, Seoul (KR); Ho Sik You, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/585,901

(22) Filed: Oct. 25, 2006

(30) Foreign Application Priority Data
Oct. 27, 2005 (KR) 10-2005-0101862

(51) Int. Cl. G03B 13/00

(52) U.S. Cl. 348/345

(57) ABSTRACT

Provided an optical system having a multiple curvature lens and a method for manufacturing the same. The optical system includes an image-forming lens group, an image sensor, and an image processing unit. The image-forming lens group has one or more multiple curvature lenses each having a multiple curvature surface provided on at least one refractive surface on one side of the multiple curvature lens. The multiple curvature surface includes two or more curved surfaces of different curvatures formed in a concentric circle. The image-forming lens group also has one or more single curvature lenses arranged before or after the multiple curvature lens and having a refractive surface. The refractive surface includes a continuous curved surface of a single curvature radius formed on both sides of the single curvature lens. The image sensor senses an image formed by the image-forming lens group, and the image processing unit recovers the image sensed by the image sensor.

### RELATED APPLICATION

The present application is based on, and claims priority from, Korean Application Number 2005-101862, filed Oct. 27, 2005, the disclosure of which is hereby incorporated by reference herein in its entirety.

### BACKGROUND OF THE INVENTION

1. Field of the Invention

The present invention relates to an imaging optical system, and more particularly, to an imaging optical system for increasing a depth of field and thus providing an improved image quality over various object distances without a lens driving unit.

2. Description of the Related Art

Generally, in a fixed focus optical system, a point spread function (PSF) seriously deteriorates and an object is not properly focused as a camera approaches the object. Particularly, when a close-up shot is performed for an object located at a distance of about 10 cm, a corresponding image seriously deteriorates.

To solve this problem, an optical system having an auto-focusing function has been proposed. However, this optical system requires transferring of a lens or an image sensor in order to provide the auto-focusing function, and thus requires a driving unit for the lens or the image sensor. Therefore, an optical apparatus to which the optical system having the auto-focusing function is applied is heavy in weight and large in size.

Therefore, an apparatus or a method for obtaining an image having excellent quality over a wide range of object distances through an image process even without a driving unit for an auto-focusing function.

U.S. Pat. No. 5,748,371 discloses a method and an apparatus for increasing a depth of field of a wavefront coding optical system using a phase mask.

Referring to FIG. 1, U.S. Pat. No. 5,748,371 proposes the method and apparatus for increasing a depth of field by mounting a phase mask 20 in a conventional fixed focus optical system including a lens 25 for forming an image of an object 15, an image sensor 30 for sensing the formed image, and an image processing unit 35.

At this point, the mask 20 is disposed between the object 15 and the lens 25 to allow an optical transfer function (OTF) not to be influenced by misfocus over a predetermined object distance range.

This wavefront coding method is used to increase a depth of field and reduce an influence of misfocus by applying an aspherical phase change on a wavefront of light incident from an object using a phase mask. An image process is required to prevent reduction of a modulation transfer function (MTF) caused by the wavefront coding method and remove a spacial influence of wave coding.

However, though the above-described optical system can have PSFs of a similar size over various object distances using a phase mask 20, the size of the PSF is relatively large and asymmetric (refer to FIG. 4B and 5C), so that an MTF considerably reduces over all object distances (refer to FIG. 7B).

That is, according to the above-described the optical system, an image seriously deteriorates and image quality of a recovered image is poor.

Therefore, an optical system and an image processing method for realizing excellent image quality over a wide range of object distances even without using a driving unit in a fixed focus optical system, is highly required.

### SUMMARY OF THE INVENTION

Accordingly, the present invention is directed to an optical system having a multiple curvature lens and a manufacturing method thereof that substantially obviate one or more problems due to limitations and disadvantages of the related art.

An object of the present invention is to provide an optical system having a multiple curvature lens and a manufacturing method thereof, capable of realizing an excellent image over various object distances including a close distance and an infinite distance.

Another object of the present invention is to provide an optical system having a multiple curvature lens and a manufacturing method thereof, capable of increasing a depth of field and achieving a PSF of a small size and an excellent MTF characteristic.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an optical system including: an image-forming lens group having one or more multiple curvature lenses each having a multiple curvature surface provided on at least one refractive surface on one side of the multiple curvature lens, the multiple curvature surface including two or more curved surfaces of different curvatures formed in a concentric circle, and having one or more single curvature lenses arranged before or after the multiple curvature lens and having a refractive surface including a continuous curved surface of a single curvature radius formed on both sides of the single curvature lens; an image sensor for sensing an image formed by the image-forming lens group; and an image processing unit for recovering the image sensed by the image sensor.

The at least one refractive surface on which the multiple curvature surface is formed may include a refractive surface having a greatest refractive power, selected from refractive surfaces of the lenses provided to the image-forming lens group.

The refractive surfaces on each of which the multiple curvature surface is formed may include refractive surfaces having a relatively large refractive power, selected from refractive surfaces of the lenses provided to the image-forming lens group.

The multiple curvature surface may be formed on one of a spherical refractive surface and an aspherical refractive surface.

Each of the curved surfaces formed on the multiple curvature surface may be one of a spherical surface and an aspherical surface.

The number of the curved surfaces formed on the multiple curvature surface of the multiple curvature lens may be identical to or greater than the number of target object distances set in advance such that an object is focused for each of the target object distances.

Each of the curved surfaces formed on the multiple curvature surface of the multiple curvature lens may have a curvature radius set such that an object is focused for the target object distance.

The target object distances may include a target close-up shot distance set in advance such that an object located at a close distance is focused, and a target infinite object distance set in advance such that an object located at a distance corresponding to infinity is focused.

The target object distances may include a target intermediate object distance set in advance such that an object located at a distance between the target close-up shot distance and the target infinite object distance is focused, and two or more target intermediate object distances can be set.

Areas of the curved surfaces formed on the multiple curvature surface of the multiple curvature lens may be the same.

An area of each of the curved surfaces formed on the multiple curvature surface of the multiple curvature lens may be ±50% of an area of each of the curved surface which is supposed that an area of each of the curved surfaces is same.

An area of a curved surface formed on a center of the multiple curvature surface may be greater than an area of each of the other curved surfaces.

The image processing unit may recover an image using a PSF (point spread function).

According to an aspect of the present invention, there is provided a method for manufacturing an optical system having a multiple curvature lens, the method including: setting a fixed focus type image-forming lens group having at least one lens; selecting at least one refractive surface of a multiple curvature lens on which a multiple curvature surface is to be formed from refractive surfaces of lenses provided to the image-forming lens group, the multiple curvature surface having two or more curved surfaces of different curvatures formed in a concentric circle; and forming a plurality of curved surfaces such that the refractive surface of the multiple curvature lens constitutes the multiple curvature surface.

The selecting may include selecting a refractive surface on which the multiple curvature surface is to be formed such that a refractive surface having a greatest refractive power is selected from refractive surfaces of lenses provided to the image-forming lens group.

The selecting may include selecting refractive surfaces on each of which the multiple curvature surface is to be formed such that a plurality of refractive surfaces are selected in an order of relatively large refractive powers from refractive surfaces of lenses provided to the image-forming lens group.

The selecting may include selecting a refractive surface on which the multiple curvature surface is to be formed from spherical surfaces and aspherical surfaces of the lenses provided to the image-forming lens group.

The forming of the plurality of curved surfaces may include: determining the number of curved, surfaces constituting the multiple curvature surface; determining an area of each of the curved surfaces constituting the multiple curvature surface; and determining a curvature radius of each of the curved surfaces constituting the multiple curvature surface.

The determining of the number of the curved surfaces may include determining the number of the curved surfaces such that the number of the curved surfaces is identical to or greater than the number of target object distances set in advance such that an object is focused for each of the target object distances.

The target object distances may include a target close-up shot distance set in advance such that an object located at a close distance is focused, and a target infinite object distance set in advance such that an object located at a distance corresponding to infinity is focused.

The target object distances may further include a target intermediate object distance set in advance such that an object located at a distance between the target close-up shot distance and the target infinite object distance is focused, and two or more target intermediate object distances can be set.

The determining of the area may include determining the areas of the curved surfaces such that the areas of the curved surfaces are the same.

The determining of the area may include determining the area of each of the curved surfaces such that the area of each of the curved surfaces is ±50% of an area of each of the curved surface which is supposed that an area of each of the curved surfaces is same.

The determining of the area may include determining the area of each of the curved surfaces such that the area of the curved surface formed on a center of the multiple curvature surface is greater than an area of each of the other curved surfaces.

The determining of the curvature radius may include determining the curvature radius of each of the curved surfaces that corresponds to each target object distance such that an object is focused for each target object distance.

The determining of the curvature radius may include determining the curvature radius such that each curved surface formed on the multiple curvature surface constitutes one of a spherical surface and an aspherical surface.

The method may further include: installing an image sensor to sense an image formed by the lens; and installing an image processing unit for recovering the image sensed by the image sensor.

The image processing unit may recover the image using a PSF (point spread function).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating an optical system to which a conventional mask is applied;

FIG. 2 is a view of an optical system having a multiple curvature lens according to the present invention;

FIG. 3 is a schematic view of a multiple curvature lens according to the present invention;

FIGS. 4A to 4C are spot diagrams of a conventional fixed focus optical system, a conventional wavefront coding optical system, and an optical system of the present invention, respectively;

FIGS. 5A and 5D are views illustrating PSF images according to a conventional art and the present invention;

FIGS. 6A to 6D are graphs illustrating line spread functions (LSFS) of the conventional art and the present invention;

FIGS. 7A to 7C are graphs illustrating MTFs according to the conventional art and the present invention;

FIGS. 8A to 8C are graphs illustrating MTFs depending on the number of curved surfaces;

FIGS. 9A and 9B are graphs illustrating MTFs depending on an area ratio of curved surfaces according to the present invention;

FIG. 10 is a graph illustrating MTFs at target close-up distances of the conventional art and the present invention;

FIGS. 11A to 11E are diagrams illustrating image recovery according to the conventional art and the present invention;

FIG. 12 is a view illustrating a lens construction of an optical system used in an example comparing the conventional art with the present invention; and

FIG. 13 is a flowchart illustrating a method for manufacturing an optical system according to the present invention.

### DETAILED DESCRIPTION OF THE INVENTION

Reference will now be made in detail to the preferred embodiments of the present invention, examples of which are illustrated in the accompanying drawings.

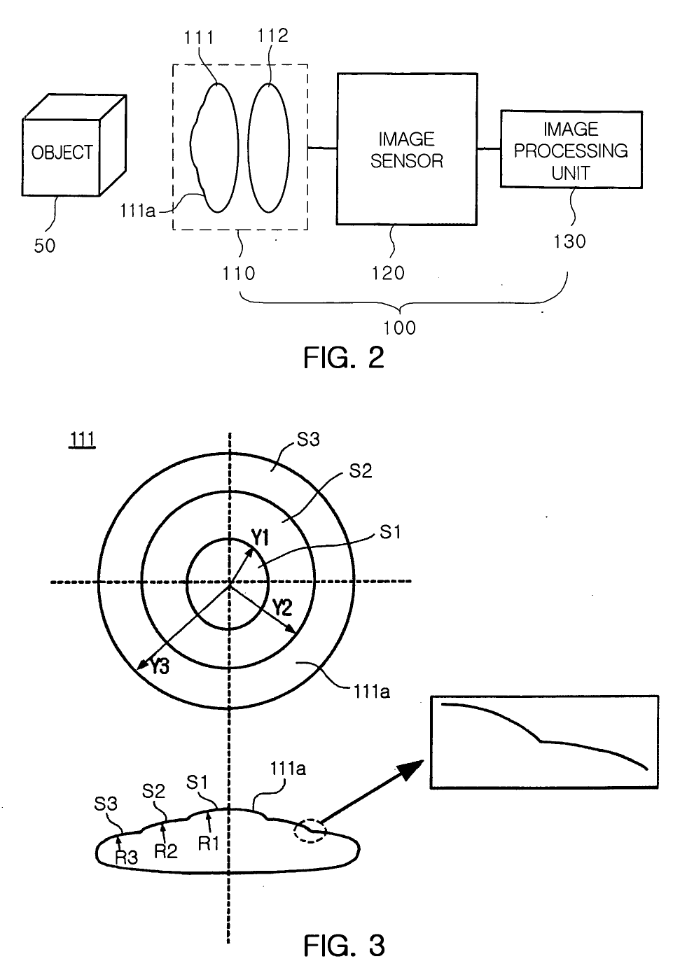

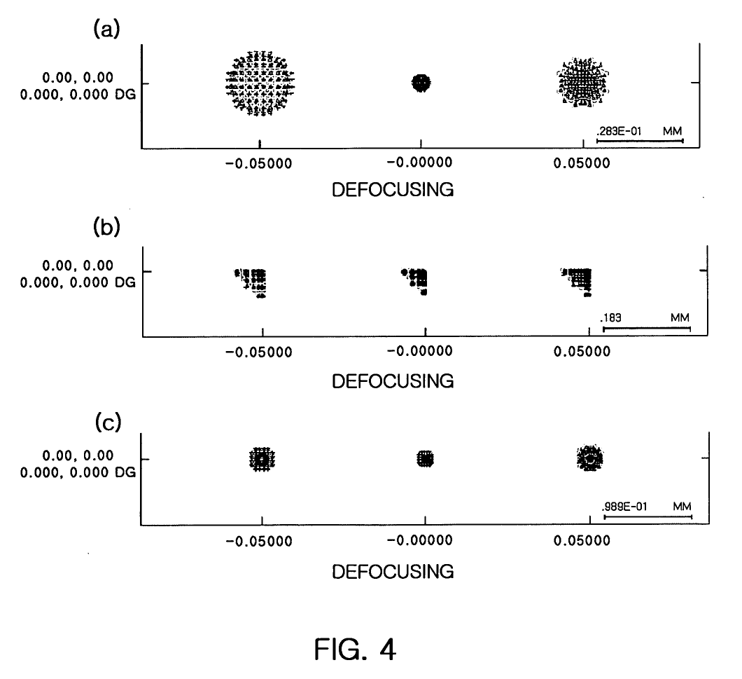

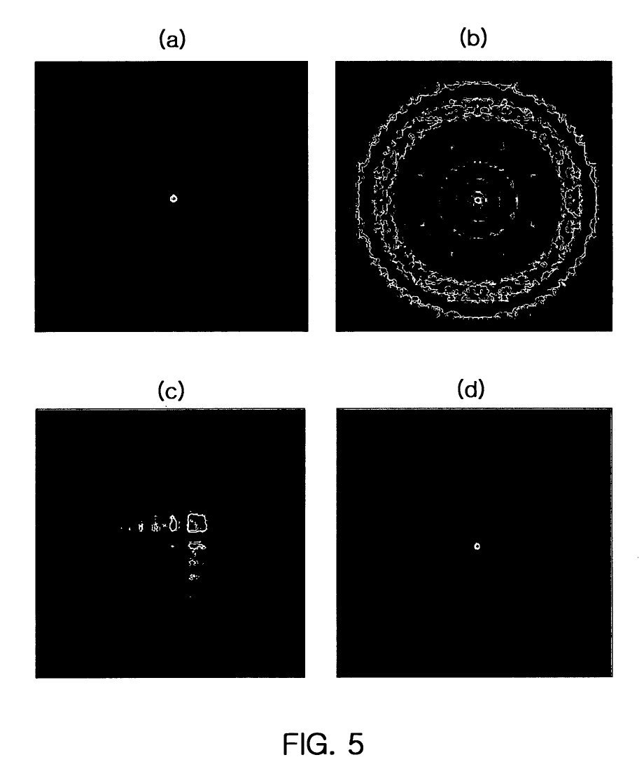

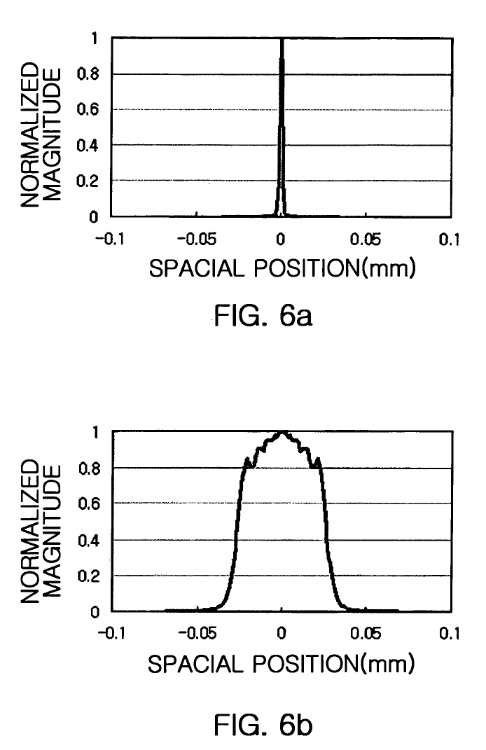

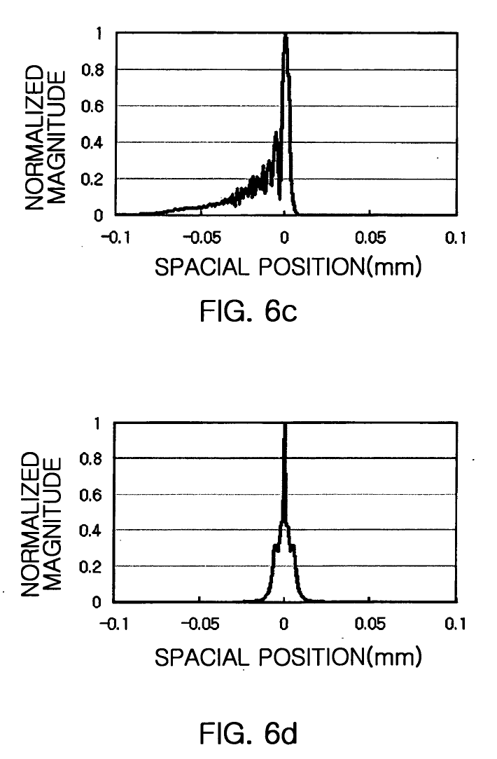

FIG. 2 is a view of an optical system having a multiple curvature lens according to the present invention, FIG. 3 is a schematic view of a multiple curvature lens according to the present invention, FIGS. 4A to 4C are spot diagrams of a conventional fixed focus optical system, a conventional wavefront coding optical system, and an optical system of the present invention, respectively, FIGS. 5A and 5D are views illustrating PSF images according to a conventional art and the present invention, and FIGS. 6A to 6D are graphs illustrating line spread functions (LSFS) of the conventional art and the present invention.

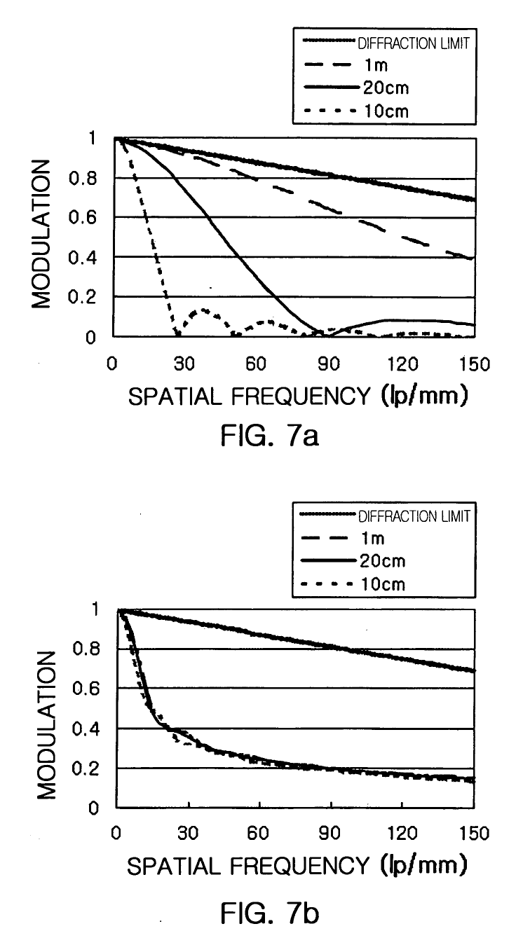

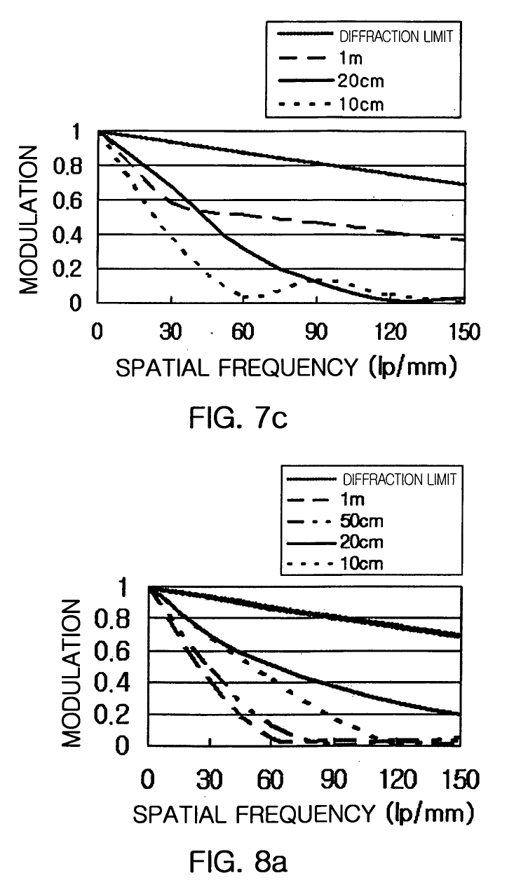

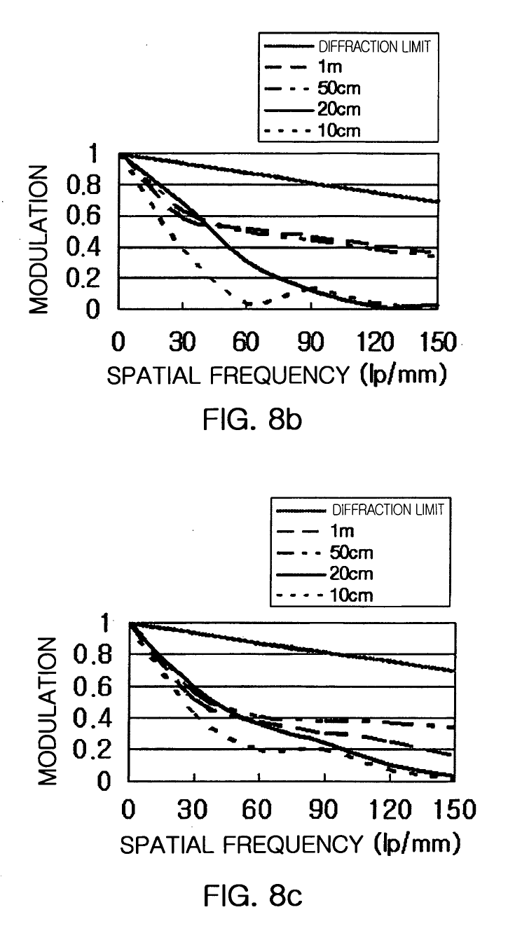

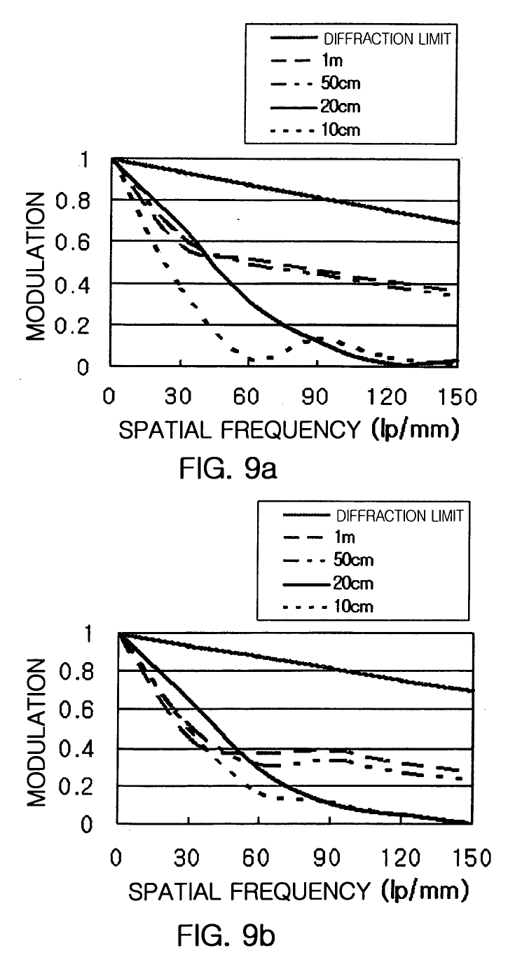

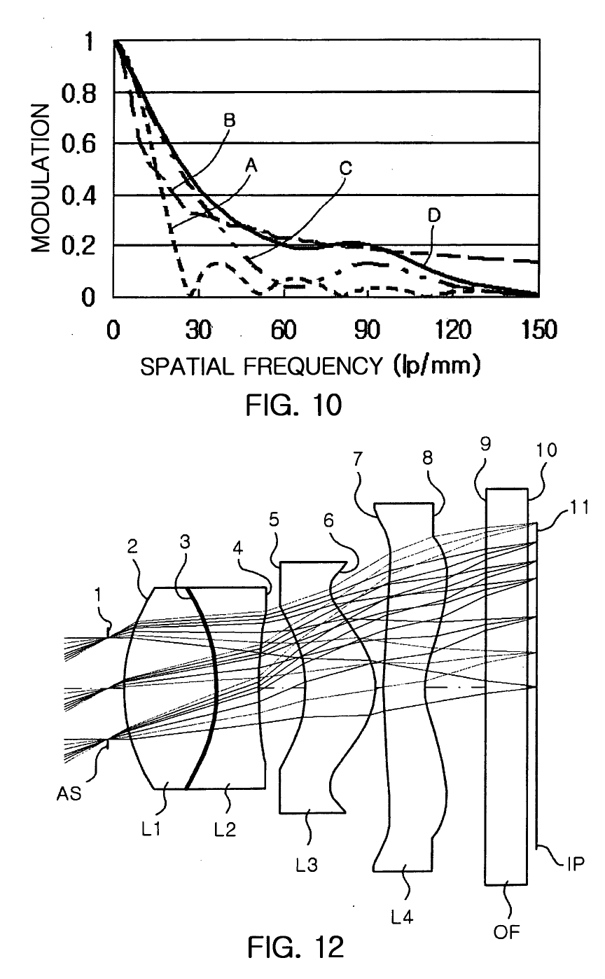

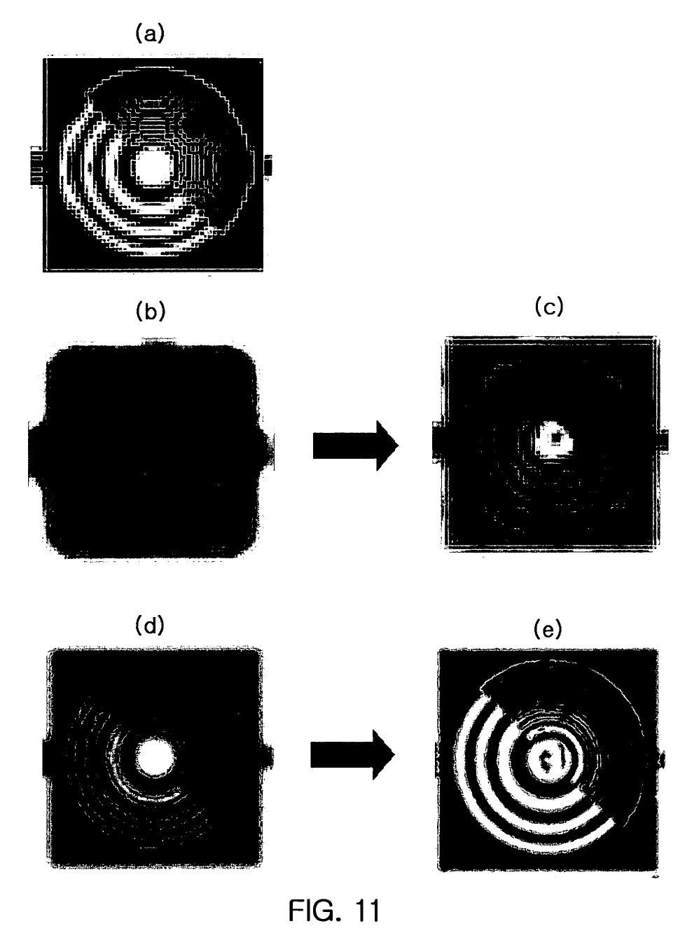

Also, FIGS. 7A to 7C are graphs illustrating MTFs according to the conventional art and the present invention, FIGS. 8A to 8C are graphs illustrating MTFs depending on the number of curved surfaces, FIGS. 9A and 9B are graphs illustrating MTFs depending on an area ratio of curved surfaces according to the present invention, FIG. 10 is a graph illustrating MTFs at target close-up distances of the conventional art and the present invention, FIGS. 11A to 11E are diagrams illustrating image recovery according to the conventional art and the present invention, and FIG. 12 is a view illustrating a lens construction of an optical system used in an example comparing the conventional art with the present invention.

An optical system having a multiple curvature lens according to the present invention can obtain an excellent image by forming a plurality of non-continuous curved surfaces on a refractive surface of a lens so that an object is focused over various object distances to increase a depth of field and decrease a size of a PSF.

Referring to FIG. 2, an optical system 100 having a multiple curvature lens according to the present invention includes an image-forming lens group 110 for forming an image of an object 50, an image sensor 120 for sensing the image formed by the image-forming lens group 110, and an image processing unit 130 for processing the image sensed by the image sensor 120.

The image-forming lens group 110 includes at least one multiple curvature lens 111 and at least one single curvature lens 112. A multiple curvature surface 111a including two or more curved surfaces of a different curvature radius formed in a concentric shape is provided on a refractive surface on at least one side of the multiple curvature lens 111. The single curvature lens 112 is disposed on back or forth of the multiple curvature lens 111, and includes a refractive surface having a continuous curved surface of a single curvature radius and formed on both sides of the single curvature lens.

The multiple curvature lens 111 or the single curvature lens 112 provided to the image-forming lens group 110 may include a plurality of lenses in order to realize an optical performance of an optical system. There is no limitation in the shape of the lenses 111 and 112, a refractive power arrangement, and the number of lenses provided to the image-forming lens 110 as far as the image-forming lens group 110 is a fixed focus type. That is, the image-forming lens group 110 has the same structure as that of a conventional fixed focus type optical system except that the multiple curvature surface 111a is formed on the multiple curvature lens 111.

Also, the image sensor 120 may be a known sensor such as a charge coupled device (CCD) and a complementary metal oxide semiconductor (CMOS).

The image processing unit 130 may be a known image processing means such as a unit for processing an image using a PSF. Particularly, since an optical system according to the present invention has a small-sized symmetric PSF and recovers an image using the PSF, the optical system has an advantage in recovering an image compared to a conventional art.

The multiple curvature lens 111 according to the present invention will be described with reference to FIG. 3.

Two or more curved surfaces each having a different curvature radius are provided on the multiple curvature lens 111.

For example, referring to FIG. 3, the multiple curvature lens 111 can include a first curved surface S1 constituting a circle of a curvature radius R1 and a radius Y1, a second curved surface S2 formed on a ring-shaped surface of a curvature radius R2 and radii of Y1-Y2, a third curved surface S3 formed on a ring-shaped surface of a curvature radius R3 and radii of Y2-Y3.

At this point, a refractive surface on which the multiple curvature surface 111a can be a refractive surface having largest refractive power selected from refractive surfaces of the lenses 111 and 112 provided to the image-forming lens group 110. That is, the multiple curvature surface 111a is formed on the refractive surface having the largest refractive power, so that an effect of increasing a depth of field can be enhanced.

Also, the multiple curvature surface 111a is formed on two or more refractive surfaces of the lenses provided to the image-forming lens group 110, so that a depth of field can be increased even more. In this case, the multiple curvature surface 111a can be formed on refractive surfaces having relatively large refractive powers of refractive surfaces of the lenses provided to the image-forming lens group 110.

The multiple curvature surface 111a can be formed on both a spherical refractive surface and an aspherical refractive surface of a lens provided to the image-forming group 110.

Meanwhile, the number of curved surfaces S1, S2, and S3 formed on the multiple curvature surface 111a of the multiple curvature lens 111 can be set to the same as the number of target object distances set in advance such that an object is focused at each of the target object distances.

That is, the target object distances can include a target close-up shot distance L_{macro} set in advance such that an object at a close distance is focused and a target infinite object distance L_{∞} set in advance such that an object at a distance corresponding to infinity is focused. In addition, the target object distance can further include a target intermediate object distance L_{mid} set in advance such that an object located at a distance between a target close-up shot distance L_{macro} and a target infinite object distance L_{∞}.

For example, in case where an object is set to be focused at two target object distances including a target infinite object distance L_{∞} set in advance such that an object at a distance of 1 m (corresponding to infinity) is focused, and a target close-up shot distance L_{macro} set in advance such that an object at a close distance of 10 cm is focused, two curved surfaces can be formed to correspond to the target object distances, respectively.

Also, in case where an object is set to be focused at three target object distances including a target infinite object distance L_{∞} set in advance such that an object at a distance of 1 m (corresponding to infinity) is focused, a target close-up shot distance L_{macro} set in advance such that an object at a close distance of 10 cm is focused, and a target intermediate object distance Laid set in advance such that an object at a distance of 20 cm is focused, three curved surfaces can be formed to correspond to the target object distances, respectively.

At this point, two or more target intermediate object distance L_{mid} can be set.

For example, two target intermediate object distances including a first target intermediate object distance L_{mid1} of 20 cm and a second target intermediate object distance L_{mid2} of 50 cm can be set between the target infinite object distance L_{∞} and the target close-up shot distance L_{macro}. In this case, four curved surfaces optimized for the target infinite object distance L_{∞}, the target close-up shot distance L_{macro}, the first target intermediate object distance L_{mid1}, and the second target intermediate object distance L_{mid2} can be formed on the multiple curvature surface 111a.

Unlike this, two or more curved surfaces for one object distance can be formed. For example, in case where four curved surfaces are formed on the multiple curvature surface 111a, two curved surfaces separated from each other can be formed to correspond to one of the target infinite object distance L_{∞}, the target close-up shot distance L_{macro}, and the target intermediate object distance L_{mid}. In this case, the number of the curved surfaces formed on the multiple curved surface 111a is greater than the number of the target object distances.

When the number of the curved surfaces formed on the multiple curvature surface 111a increases as described above, a depth of field increases, so that an object is well focused over various object distances, and image quality deterioration at a close-up distance, which is a problem of a fixed focus optical system, can be complemented (refer to FIG. 8). That is, since a plurality of curved surfaces corresponding to various object distances are formed on one refractive surface, a depth of field increases and an MTF performance improves compared to a conventional fixed focus optical system.

Meanwhile, areas of the curved surfaces formed on the multiple curvature surface 111a of the multiple curvature lens 111 can be the same.

For example, in case where three curved surfaces S1, S2, and S3 are formed on the multiple curvature surface 111a as illustrated in FIG. 3, an area ratio of the respective curved surface can be set to 1:1:1. That is, an improvement in an MTF is expected for an entire object distance by allowing the same light amount to be incident for the object distances corresponding to the respective curved surfaces. A radius ratio of the respective curved surfaces, that is, Y1:Y2:Y3 can be set to 1:\sqrt{3}:\sqrt{5} such that an area ratio of the respective curved surfaces is 1:1:1.

Unlike this, the MTF can be improved by increasing a light amount for a predetermined object distance. That is, a degree a predetermined object distance contributes to a depth of field can be controlled.

For example, in case where design specification requires great image quality improvement for the target close-up shot distance L_{macro}, an incident light amount of a curved surface corresponding to the target close-up shot distance L_{macro} can be increased.

That is, the second curved surface S2 of FIG. 3 corresponds to the target close-up shot distance L_{macro}, the second curved surface S2 can be formed to have a greater area than those of the first curved surface S1 and the third curved surface S2.

An area of each of the curved surfaces formed on the multiple curvature surface 111a of the multiple curvature lens 111 can be set to ±50% of an area of each of the curved surface which is supposed that an area of each of the curved surfaces is same. That is, an area ratio of the curved surfaces can be set to 0.5-1.5:0.5-1.5:0.5-1.5, and an area of a predetermined curved surface corresponding to a predetermined object distance can be made large.

However, when the area of the predetermined curved surface deviates from this range, an influence of the predetermined curved surface on a depth of field excessively increases or decreases, so that image quality improvement for various object distances may not be effective.

Also, an image quality improvement effect can be increased for an object distance corresponding to the curved surface S1 (FIG. 3) formed on the center of the multiple curvature surface 111 by forming an area of the curved surface S1 larger than those of the other curved surfaces S2 and S3.

Meanwhile, radii of the curved surfaces formed on the multiple curvature surface 111a of the multiple curvature lens 111 are set such that an object is focused at each of the corresponding target object distances.

For example, a radius of the curved surface corresponding to the target infinity object distance is set such that an object located at the target infinite object distance L_{∞} is focused. The curved surface can be one of a spherical surface and an aspherical surface. Particularly, in case of a spherical surface, various aberrations originating from a spherical surface can be corrected.

For example, in case where three curved surfaces S1, S2, and S3 are formed on the multiple surface 111a as illustrated in FIG. 3, a curvature radius R1 of the first curved surface S1 can be set to be a curvature radius R_{mid} optimized for the target intermediate object distance L_{mid}, a curvature radius R2 of the second curved surface S2 can be set to be a curvature radius R_{macro} optimized for the target close-up distance L_{macro}, and a curvature radius R3 of the third curved surface S3 can be set to be a curvature radius R_{∞} optimized for the target infinity object distance L_{∞}.

The object distances corresponding to the curved surfaces are not limited to the above examples, but can have arbitrary order depending on design specification.

Also, in case where two curved surfaces are formed, curved surfaces can be set to have a curvature radius R_{∞} optimized for the target infinity object distance L_{∞}, and a curvature radius R_{macro} optimized for the target close-up distance L_{macro}, respectively.

Also, in case that four curved surfaces are formed, the four curved surfaces can be set to have a curvature radius R_{∞} optimized for the target infinity object distance L_{∞}, a curvature radius R_{macro} optimized for the target close-up distance L_{macro}, a curvature radius R_{mid1} optimized for a first target intermediate object distance L_{mid1}, and a curvature radius R_{mid2} optimized for a second target intermediate object distance L_{mid2}. Unlike this, one target intermediate object distance L_{mid} can be set to two curved surfaces.

An operation of an optical system including the multiple curvature lens 111, having the above-described construction will be described in comparison of a conventional art (specific numerical values of optical systems according to a conventional art and the present invention will be given later).

Referring to FIG. 4A illustrating a spot diagram of a fixed focus optical system at an object distance where an object is accurately focused, the optical system has a root-mean-square (RMS) spot diameter of 15.59 μm at defocusing of −0.05 mm, 3.04 μm at defocusing of 0.00 mm, and 9.95 μm at defocusing of ±0.05 mm. Also, referring to FIG. 5A, in case of a conventional fixed focus optical system, a PSF also has very small size at an object distance where an object is accurately focused. Accordingly, referring to FIG. 6A, a spacial position of a line spread function (LSF), which is one-dimensional function of the PSF, becomes very small.

However, in the conventional fixed focus optical system, a PSF drastically increases at a close-up distance of 10 cm as shown in FIG. 5B illustrating a PSF for an object located at a distance of 10 cm, and accordingly, a spacial position of a line spread function (LSF), which is one-dimensional function of the PSF, becomes very large.

Consequently, as shown in FIG. 7A illustrating an MTF of a conventional fixed focus optical system, an MTF performance drastically decreases at a close-up distance of 10 cm compared to a infinite object distance of 1 m where an object is well focused. Also, the conventional fixed focus optical system has a spacial frequency of about 20 lp/mm for an MTF of 30%, and has a spacial frequency of about 18 lp/mm for an MTF of 40%, so that an optical characteristic decreases.

As described above, in a fixed focus optical system, as an object distance is small, a size of a PSF drastically increases, so that image quality seriously deteriorates.

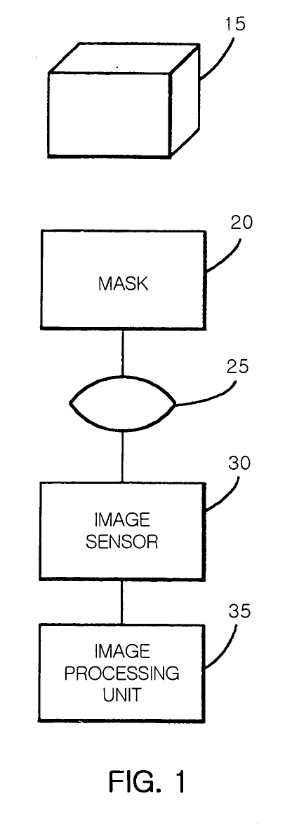

Also, in case of a conventional optical system (FIG. 1) applying a mask (a mask CPM 127-R20 by CDM Optics Co.) to a general fixed focus optical system, an RMS spot diameter of a spot diagram is 42.00 μm at defocusing of −0.05 mm, 39.69 μm at defocusing of 0.00 mm, and 41.34 μm at defocusing of +0.05 mm as illustrated in FIG. 4B.

That is, the conventional optical system using a mask has spot diameters of similar sizes around a focus but the size is relatively large and asymmetric.

Also, as shown in FIG. 5C illustrating a close-up shot at an object distance of 10 cm, a conventional optical system using a mask has a relatively large and asymmetric PSF compared to the PSF of FIG. 5A. Accordingly, referring to FIG. 6C, a spacial position of a line spread function (LSF), which is one-dimensional function of a PSF becomes large on the whole as illustrated in FIG. 6C.

That is, compared to FIG. 6A illustrating an LSF where an object is well focused in a fixed focus optical system, a spacial position becomes large when a close-up shot (FIG. 6C) is performed at an object distance of 10 cm in a conventional optical system using a mask.

Also, referring to FIG. 7B, the conventional fixed focus optical system has a spacial frequency of about 35 lp/mm for an MTF of 30%, and has a spacial frequency of about 20 lp/mm for an MTF of 40%, so that an optical characteristic decreases.

As described above, even in case of an optical system using a mask, a size of a PSF increases over an entire object distance, image quality seriously deteriorates, and recovered image quality is poor.

On the other hand, an optical system to which a triple curvature lens is applied (FIG. 4C) according to the present invention has an RMS spot diameter of 14.49 μm at defocusing of −0.05 mm, 9.01 μm at defocusing of 0.00 mm, and 17.40 μm at defocusing of +0.05 mm, so that a diameter of a spot becomes very small compared to the conventional optical system using the mask (FIG. 4B).

Also, as shown in FIG. 5D illustrating a PSF at a target close-up distance of 10 cm when a triple curvature lens is used according to the present invention, an optical system according to the present invention has a very small PSF. That is, an optical system according to the present invention has a remarkably small and almost symmetric PSF at a target close-up distance compared to that of a conventional fixed focus optical system or a conventional optical system using a mask. Accordingly, referring to FIG. 6D, in case of a close-up shot at an object distance of 10 cm, a spacial position of an LSF, which is one-dimensional function of a PSF, remarkably decreases compared to those of FIG. 6B and 6C.

Also, referring to FIG. 7C, the optical system according to the present invention has a spacial frequency of about 35 lp/mm for an MTF of 30%, and has a spacial frequency of about 30 lp/mm for an MTF of 40%, so that an optical characteristic is excellent compared to the conventional optical systems of FIGS. 7A and 7B. Particularly, when an area of a curved surface corresponding to a target close-up distance of 10 cm is increased in order to increase an influence of the target object close-up distance of 10 cm on a depth of field, an MTF characteristic at the close-up distance improves, so that an MTF performance can improve on the whole.

Since an optical system according to the present invention has a small and symmetric PSF, the optical system has an advantage in recovering an image compared to a conventional optical system.

Meanwhile, FIGS. 8A to 8C illustrate MTF characteristics depending on the number of curved surfaces formed on a multiple curvature surface according to the present invention. FIG. 8A illustrates a case for a double curvature lens, FIG. 8B illustrates a case for a triple curvature lens, and FIG. 8C illustrates a case for a quadruple curvature lens.

Referring to FIGS. 8A to 8C, as the number of curved surfaces formed on the multiple curved surface increases, an MTF improves. That is, an object is well focused over various object distances and image quality deterioration at a close-up distance, which is a problem of a conventional fixed focus optical system, can be complemented by increasing the number of curved surfaces optimized for the various object distances.

Also, FIGS. 9A and 9B illustrate MTF characteristics depending on an area ratio of a curved surface formed on the multiple curved surface of a triple curvature lens. FIG. 9A illustrates a case for an area ratio of 1:1:1, and FIG. 9B illustrates a case for an area ratio of 1:1.5:1.

At this point, curved surfaces optimized for a target intermediate object distance of 20 cm, a target close-up distance of 10 cm, and a target infinite object distance of 1 m are formed on the multiple curvature surface sequentially from the center of the multiple curvature surface.

Comparison of FIG. 9A with FIG. 9B shows that when an influence of the curved surface corresponding to the target close-up distance of 10 cm is made large as in FIG. 9B, an MTF characteristic at the target close-up distance of 10 cm remarkably improves compared to that of FIG. 9A.

As described above, an MTF characteristic at a predetermined object distance and over an entire object distance can be controlled by controlling an influence of the curved surface corresponding to the predetermined object distance on a depth of field.

Meanwhile, FIG. 10 illustrate MTF characteristics of a conventional art and the present invention at a target close-up distance of 10 cm. A curve A represents a conventional fixed focus optical system, a curve B represents a conventional optical system (the optical system of FIG. 1) using a mask, a curve C represents an optical system having a triple curvature lens according to the present invention, and a curve D represents an optical system having a quadruple curvature lens according to the present invention.

Referring to FIG. 10, the MTF characteristics are excellent in an order of the conventional fixed focus optical system (A), the conventional optical system using the mask (B), the optical system having the triple curvature lens according to the present invention (C), and the optical system having the quadruple curvature lens according to the present invention (D). That is, the present invention has a remarkably excellent MTF at a target object distance compared to the conventional art. As the number of the curved surfaces formed on the multiple curvature surface increases, an MTF performance improves.

FIG. 11 illustrates images (FIGS. 11B and 11C) of a general fixed focus optical system and images (FIGS. 11D and 11E) of an optical system according to the present invention at the same close-up distance of 10 cm before and after recovery.

At this point, an object is a center image of an ISO 12233 resolution target.

FIG. 11A illustrates a case where an object is well focused at a close-up distance and a corresponding image does not need to be recovered.

However, comparison of the images before and after recovery shown in FIGS. 11B and 11C by the fixed focused optical system with the images before and after recovery shown in FIGS. 11D and 11E by the optical system according to the present invention, shows that an image quality of the image (FIG. 11E) recovered according to the present invention is more excellent than that of the conventional fixed focused optical system.

This is because a before-recovery image quality is excellent and a size of a PSF referred to during a recovery operation is small according to the present invention compared to those of the conventional fixed focus optical system and the conventional optical system using the mask.

For comparison of a conventional optical system with an optical system according to the present invention, the optical system illustrated in FIG. 12 is used.

Referring to FIG. 12, the conventional fixed focus optical system, the conventional optical system using the mask (FIG. 1), and an optical system according to the present invention includes, sequentially from an object side: an aperture stop (AS), a first lens L1, a second lens L2, a third lens L3, a fourth lens L4, an infrared filter (optical filter: OF), and an image plane (image sensor: IS). At this point, an effective focal length f of an entire system is 3.5119 mm, an F number F_{No} is 2.8, an entire angle of view 2ω is 60° , and a pixel pitch of the image plane is 3.5 μm.

The conventional optical system using the mask (FIG. 1) uses a mask of a CPM 127-R20 by CDM Optics Co. between the aperture stop (AS) and an object side 2 of the first lens L1 of the conventional fixed focus optical system.

Also, unlike the conventional optical system, the optical system according to the present invention provides a multiple curvature surface on the object side 2 of the first lens L1, so that a curvature radius changes.

Specific numerical values of the optical system illustrated in FIG. 12 are given by Table 1 below.

TABLE 1

| | | Thickness | | | |
|---|---|---|---|---|---|
| | | or interval | | | |
| | Radius of | between | | | |
| surface | curvature | surfaces | Refractive | Abbe | |
| No. | R(mm) | (mm) | index | number | Remark |
| 1 | ∞ | 0.2000 | — | — | Aperture |
| | | | | | stop(AS) |
| 2 | #1 | 1.1000 | 1.8042 | 46.5 | 1^{st} lens |
| 3 | −2.3629 | 0.5000 | 1.8052 | 25.4 | 2^{nd} lens |
| *4 | 5.3543 | 0.5706 | — | — | |
| *5 | −1.8321 | 0.8412 | 1.5312 | 56.0 | 3^{rd} lens |
| *6 | −0.8481 | 0.1000 | — | — | |
| *7 | 3.8342 | 0.5000 | 1.5312 | 56.0 | 4^{th} lens |
| *8 | 0.9548 | 0.7888 | — | — | |
| 9 | ∞ | 0.5000 | 1.5168 | 64.1 | Infrared |
| | | | | | filter |
| 10 | ∞ | 0.1000 | — | — | |
| 11 | ∞ | — | — | — | Image |
| | | | | | plane |

In table 1, #1 has different values as given by Table 2 below for the conventional optical system and the optical system according to the present invention.

Also, Table 2 gives curvature radii of respective curved surfaces (sequentially corresponding to R1, R2, and R3 of FIG. 3) and radii of the respective curved surfaces (sequentially corresponding to Y1, Y2, and Y3 of FIG. 3) in association with double, triple, and quadruple curvature lenses where two, three, and four curved surfaces are formed on multiple curvature surfaces of the lenses, respectively.

At this point, the double curvature lens has a curved surface optimized for a target close-up distance of 10 cm, and a curved surface optimized for a target infinite object distance of 1 m, the curved surfaces being sequentially formed from a center portion of the double curvature lens.

Also, the triple curvature lens has a curved surface optimized for a target intermediate object distance of 20 cm, a curved surface optimized for a target close-up distance of 10 cm, and a curved surface optimized for a target infinite object distance of 1 m, the curved surfaces being sequentially formed from a center portion of the triple curvature lens.

Also, the quadruple curvature lens has a curved surface optimized for a first target intermediate object distance of 20 cm, a curved surface optimized for a target close-up distance of 10 cm, a curved surface optimized for a second target intermediate object distance of 50 cm, and a curved surface optimized for a target infinite object distance of 1 m, the curved surfaces being sequentially formed from a center portion of the quadruple curvature lens.

Areas of the curved surfaces of the double, triple, and quadruple curvature lenses are the same except a case of FIG. 9B. For example, an area ratio of the curved surfaces of the triple curvature lens is 1:1:1. On the other hand, an area ratio of the curved surfaces used in FIG. 9B is 1:1.5:1.

Here, a curved surface formed on a multiple curvature lens can have a curvature radius deviating more or less from an optimized curvature radius in order to be connected to an adjacent curved surface.

That is, though a second curved surface S2 of the triple curvature lens and a second curved surface S2 of the quadruple curvature lens correspond to a target close-up distance, they can have a curvature radius deviating more or less from an optimized curvature radius in order to be connected to an adjacent curved surface.

TABLE 2

| | | | | Radius of each |
|---|---|---|---|---|
| | | | | curvature surface |
| | | | | (half of effective |
| | | | #1 | diameter) |
| Conventional fixed focus | | | 2.3482 | 0.8404 |
| type | | | | |
| (single curvature lens) | | | | |
| Present | Double | R1 | 2.3029 | 0.5943 |
| invention | curvature | R2 | 2.3431 | 0.8404 |
| | lens | | | |
| | Triple | R1 | 2.3385 | 0.4852 |
| | curvature | R2 | 2.3033 | 0.6852 |
| | lens | R3 | 2.3431 | 0.8404 |
| | Quadruple | R1 | 2.3252 | 0.4202 |
| | curvature | R2 | 2.3029 | 0.5943 |
| | lens | R3 | 2.3385 | 0.7278 |
| | | R4 | 2.3431 | 0.8404 |

On the other hand, * in Table 1 represents an aspherical surface, and the aspherical surface is obtained using Equation 1 below.
Z=(Y²/r)[1+\sqrt{1−(1+K)(Y/r)²}]+AY⁴+By⁶+CY⁸+DY¹⁰+EY¹⁰ Equation 1

Z: distance toward an optical axis from a vertex of a lens

Y: distance toward a direction perpendicular to an optical axis

r: radius of curvature on a vertex of a lens

K: conic constant

A, B, C, D, and E: aspherical coefficients

Conic constant K and aspherical coefficients A, B, C, D, and E by Equation 1 are given by Table 3 below.

TABLE 3

Surface No.

| | *5 | *6 | *7 | *8 |
|---|---|---|---|---|
| K | 0.86392 | −0.84924 | −159.64933 | −7.23343 |
| A | −0.05504 | 0.23746 | −0.03719 | −0.07748 |
| B | −0.01111 | −0.20721 | 0.03517 | 0.02599 |
| C | 0.15492 | 0.16838 | −0.01138 | −0.00514 |
| D | −0.05906 | −0.03495 | 0.00108 | 0.00016 |

A method for manufacturing an optical system having a multiple curvature lens will be described below.

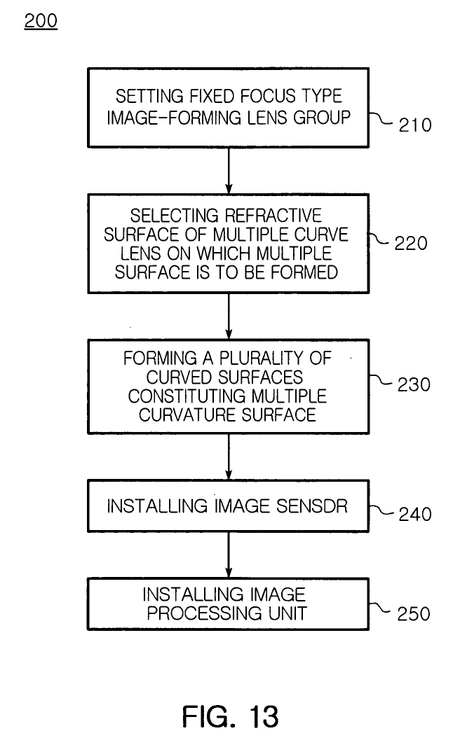

FIG. 13 is a flowchart illustrating a method 200 for manufacturing an optical system according to the present invention.

Referring to FIG. 13, the method 200 manufactures an optical system having a PSF of a small size and an increased depth of field by setting an image-forming lens group of a fixed focus type and forming a multiple curvature surface on at least one refractive surface of at least one lens provided to the image-forming lens group.

The method 200 for manufacturing the optical system according to the present invention includes operations below as illustrated in FIG. 13.

a) an operation (210) of setting an image-forming lens group of a fixed focus type;

Like a conventional fixed focus type optical system, an image-forming lens group 110 of a fixed focus type having one or more lenses is set.

Lenses provided to the image-forming lens group 110 of the fixed focus type can include a plurality of lenses in order to realize an optical performance of an optical system. There is no limitation in the shape of the lenses, a refractive power arrangement, and the number of lenses provided to the image-forming lens 110 as far as the image-forming lens group 110 is a fixed focus type.

b) an operation (220) of selecting one or more refractive surfaces of a multiple curvature lens on which a multiple curvature surface is to be formed;

One or more refractive surfaces of a multiple curvature lens are selected from refractive surfaces of lenses provided to the image-forming lens group 110. The multiple curvature lens includes the multiple curvature surface 111a having two or more curved surfaces of different curvatures formed in a concentric circle.

At this point, the refractive surface on which the multiple curvature surface 111a is to be formed can be a refractive surface having a greatest refractive power, selected from refractive surfaces of the lenses 111 and 112 provided to the image-forming lens group 110. That is, an effect of increasing a depth of field can be enhanced by forming the multiple curvature surface 111a on the refractive surface having the greatest refractive power.

Also, a depth of field can be increased by forming the multiple curvature surface 111a on two or more refractive surfaces of the lenses provided to the image-forming lens group 110. In this case, the multiple curvature surface 111a can be formed on refractive surfaces having a relatively large refractive power, selected from the refractive surfaces of the lenses provided to the image-forming lens group 110.

Also, the multiple curvature surface 111a can be formed on both a spherical refractive surface and an aspherical refractive surface of the lens provided to the image-forming lens group 110.

c) an operation (230) of forming a plurality of curved surfaces such that a refractive surface of the multiple curvature lens constitutes a multiple curvature surface;

When the refractive surface on which the multiple curvature surface 111a is to be formed is determined, a plurality of curved surfaces are formed on the refractive surface to constitute the multiple curvature surface 111a.

At this point, for forming the curved surface, the operation c) includes operations below to determine the number of curved surfaces constituting the multiple curvature surface 111a, and areas and curvature radii of the curved surfaces.

C1) an operation of determining the number of curved surfaces constituting the multiple curvature surface;

The number of the curved surfaces formed on the multiple curvature surface 111a is set first to form the multiple curvature surface 111a of the multiple curvature lens 111.

At this point, the number of the surfaces S1, S2, and S3 formed on the multiple curvature surface 111a can be set to be the same as the number of the target object distances set in advance such that an object is focused at each of the object distances.

The target object distance can include a target close-up shot distance L_{macro} set in advance such that an object at a close distance is focused and a target infinite object distance L_{∞} set in advance such that an object at a distance corresponding to infinity is focused. In addition, the target object distance can further include a target intermediate object distance L_{mid} set in advance such that an object located at a distance between a target close-up shot distance L_{macro} and a target infinite object distance L_{∞}.

For example, in case where an object is focused at three object distances including a target infinite object distance L_{∞} set in advance such that an object at a distance of 1 m (corresponding to infinity) is focused, a target close-up shot distance L_{macro} set in advance such that an object at a close-up shot distance of 10 cm, and is focused, and a target intermediate object distance L_{mid} set in advance such that an object located at a distance of 20 cm is focused, three curved surfaces can be formed to correspond to each of the above-described object distances.

At this point, two or more target intermediate object distance L_{mid} can be set.

For example, two target intermediate object distances including a first target intermediate object distance L_{mid1} for an object at a distance of 20 cm, and a second target intermediate object distance L_{mid2} for an object at a distance of 50 cm located between the target infinite object distance L_{∞} and the target close-up shot distance L_{macro} can be set. In this case, it is possible to form four curved surfaces on the multiple curvature surface 111a, the four curved surface being optimized for the target infinite object distance L_{∞}, the target close-up shot distance L_{macro}, the first target intermediate object distance L_{mid1}, and the second target intermediate object distance L_{mid2}.

Unlike this, two or more curved surfaces can be formed to correspond to one object distance. For example, in case where four curved surfaces are formed on the multiple curvature surfaces 111a, two curved surfaces separated from each other can be formed to correspond to one of the target infinite object distance L_{∞}, the target close-up shot distance L_{macro}, and the target intermediate object distance L_{mid1}. In this case, the number of the curved surfaces formed on the multiple curvature surface 111a is greater than the number of the target object distances.

When the number of the curved surfaces formed on the multiple curvature surface 111a increases, a depth of field increases, so that an object is well focused over various object distances, and image quality deterioration at a close-up shot distance, which is a problem of a fixed focus optical system, can be complemented (refer to FIG. 8). That is, a depth of field and an MTF performance improve compared to a conventional fixed focus optical system by forming a plurality of curved surfaces corresponding to various object distances on one refractive surface.

C2) an operation of determining areas of respective curved surfaces constituting the multiple curvature surface;

When the number of the curved surfaces of the multiple curvature surface is determined, an area of the refractive surface, occupied by each curved surface is determined.

At this point, areas of the curved surfaces formed on the multiple curvature surface 111a of the multiple curvature lens 111 can be set to be the same (refer to FIG. 9A).

For example, in case that three curved surfaces S1, S2, and S3 are formed on the multiple curvature surface 111a as illustrated in FIG. 3, an area ratio of the curved surfaces S1, S2, and S3 can be set to be 1:1:1. That is, an MTF improvement is expected over an entire object distance by allowing the same light amount to be incident for object distances corresponding to the curved surfaces, respectively.

A radius ratio of the respective curved surfaces, that is, Y1:Y2:Y3 can be set to 1:\sqrt{3}:\sqrt{5} such that an area ratio of the respective curved surfaces is 1:1:1.

Unlike this, the MTF can be improved by increasing a light amount for a predetermined object distance. That is, a degree a predetermined object distance contributes to a depth of field can be controlled (refer to FIG. 9B).

For example, in case where design specification requires great image quality improvement for the target close-up shot distance L_{macro}, an incident light amount of a curved surface corresponding to the target close-up shot distance L_{macro} can be increased.

An area of each of the curved surfaces formed on the multiple curvature surface 111a of the multiple curvature lens 111 can be set to ±50% of an area of each of the curved surface which is supposed that an area of each of the curved surfaces is same. That is, an area ratio of the curved surfaces can be set to 0.5-1.5:0.5-1.5:0.5-1.5, and an area of a predetermined curved surface corresponding to a predetermined object distance can be made large.

Also, an image quality improvement effect can be increased for an object distance corresponding to the curved surface S1 (FIG. 3) formed on the center of the multiple curvature surface 111 by forming an area of the curved surface S1 larger than those of the other curved surfaces S2 and S3.

C3) an operation of determining curvature radii of the curved surfaces constituting the multiple curvature surface;

Radii of the respective curved surfaces formed on the multiple curvature surface 111a of the multiple curvature lens are set such that an object located at corresponding target object distances are focused, respectively.

For example, a curvature radius of a curved surface corresponding to a target infinite object distance is optimized with consideration of aberration and set such that an object located at the target object distance L_{∞} is focused. The curved surface can be one of a spherical surface and an aspherical surface. Particularly, in case of a spherical surface, various aberrations originating from a spherical surface can be corrected.

For example, in case where three curved surfaces S1, S2, and S3 are formed on the multiple surface 111a as illustrated in FIG. 3, a curvature radius R1 of the first curved surface S1 can be set to be a curvature radius R_{mid} optimized for the target intermediate object distance L_{mid}, a curvature radius R2 of the second curved surface S2 can be set to be a curvature radius R_{macro} optimized for the target close-up distance L_{macro}, and a curvature radius R3 of the third curved surface S3 can be set to be a curvature radius R_{∞} optimized for the target infinity object distance L_{∞}. The object distances corresponding to the curved surfaces are not limited to the above examples, but can have arbitrary order depending on design specification.

d) an operation (240) of installing an image sensor;

Referring to FIGS. 2 and 13, an image sensor 120 is installed to sense an image formed by the lens group 110 having at least one multiple curvature lens 111 and at least one single curvature lens 112. The multiple curvature lens 111 includes at least one multiple curvature surface 111a, and the single curvature lens 112 is disposed before or after the multiple curvature lens 111, and has refractive surfaces each including a continuous curved surface of a single curvature radius, the refractive surfaces being formed on both sides of the single curvature lens 112, respectively.

At this point, the image sensor 120 may be a known sensor such as CCDs and CMOSs.

e) an operation (250) of installing an image processing unit;

Referring to FIGS. 1 and 13, the image processing unit 130 for recovering an image sensed by the image sensor 120 is installed.

At this point, the image processing unit 130 may be a known image processing means such as a unit for processing an image using a PSF. Particularly, since an optical system according to the present invention has a small and symmetric PSF as described above, there is an advantage that an image quality improves when an image is recovered using a PSF.

As described above, since a lens driving unit for realizing an auto focusing operation for a close-up distance and a long distance is not required according to the present invention, a small-sized and lightweight optical system can be provided.

Also, according to the present invention, an excellent image quality can be realized over a wide range of object distances including a close-up shot distance and a long distance by forming a multiple curvature surface on a refractive surface of a lens without addition or modification of an optical part in a conventional fixed focus optical system.

Also, the present invention has a small PSF and an excellent MTF characteristic and thus can obtain excellent image quality compared to a conventional fixed focus optical system or a wavefront coding optical system using a mask.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An optical system comprising:
an image-forming lens group having one or more multiple curvature lenses each having a multiple curvature surface provided on at least one refractive surface on one side of the multiple curvature lens, the multiple curvature surface including two or more curved surfaces of different curvatures formed in a concentric circle, and
having one or more single curvature lenses arranged before or after the multiple curvature lens and having a refractive surface including a continuous curved surface of a single curvature radius formed on both sides of the single curvature lens;
an image sensor for sensing an image formed by the image-forming lens group; and
an image processing unit for recovering the image sensed by the image sensor.

2. The optical system of claim 1, wherein the at least one refractive surface on which the multiple curvature surface is formed includes a refractive surface having a greatest refractive power, selected from refractive surfaces of the lenses provided to the image-forming lens group.

3. The optical system of claim 1, wherein the refractive surfaces on each of which the multiple curvature surface is formed include refractive surfaces having a relatively large refractive power, selected from refractive surfaces of the lenses provided to the image-forming lens group.

4. The optical system of claim 1, wherein the multiple curvature surface is formed on one of a spherical refractive surface and an aspherical refractive surface.

5. The optical system of claim 1, wherein each of the curved surfaces formed on the multiple curvature surface is one of a spherical surface and an aspherical surface.

6. The optical system of claim 1, wherein the number of the curved surfaces formed on the multiple curvature surface of the multiple curvature lens is identical to or greater than the number of target object distances set in advance such that an object is focused for each of the target object distances.

7. The optical system of claim 6, wherein each of the curved surfaces formed on the multiple curvature surface of the multiple curvature lens has a curvature radius set such that an object is focused for the corresponding target object distance.

8. The optical system of claim 6, wherein the target object distances include a target close-up shot distance set in advance such that an object located at a close distance is focused, and a target infinite object distance set in advance such that an object located at a distance corresponding to infinity is focused.

9. The optical system of claim 8, wherein the target object distances further include a target intermediate object distance set in advance such that an object located at a distance between the target close-up shot distance and the target infinite object distance is focused.

10. The optical system of claim 9, wherein two or more target intermediate object distances are set.

11. The optical system of claim 1, wherein areas of the curved surfaces formed on the multiple curvature surface of the multiple curvature lens are the same.

12. The optical system of claim 1, wherein an area of each of the curved surfaces formed on the multiple curvature surface of the multiple curvature lens is ±50% of an area of each of the curved surface which is supposed that an area of each of the curved surfaces is same.

13. The optical system of claim 1, wherein an area of a curved surface formed on a center of the multiple curvature surface is greater than areas of the other curved surfaces.

14. The optical system of claim 1, wherein the image processing unit recovers an image using a PSF (point spread function).

15. A method for manufacturing an optical system having a multiple curvature lens, the method comprising:
setting a fixed focus type image-forming lens group having one or more lenses;
selecting at least one refractive surface of a multiple curvature lens on which a multiple curvature surface is to be formed from refractive surfaces. If lenses provided to the image-forming lens group, the multiple curvature surface having two or more curved surfaces of different curvatures formed in a concentric circle; and
forming a plurality of curved surfaces such that the refractive surface of the multiple curvature lens constitutes the multiple curvature surface.

16. The method of claim 15, wherein the selecting comprises selecting a refractive surface on which the multiple curvature surface is to be formed such that a refractive surface having a greatest refractive power is selected from refractive surfaces of lenses provided to the image-forming lens group.

17. The method of claim 15, wherein the selecting comprises selecting refractive surfaces on each of which the multiple curvature surface is to be formed such that a plurality of refractive surfaces are selected in an order of relatively large refractive powers from refractive surfaces of lenses provided to the image-forming lens group.

18. The method of claim 15, wherein the selecting comprises selecting a refractive surface on which the multiple curvature surface is to be formed from spherical surfaces and aspherical surfaces of the lenses provided to the image-forming lens group.

19. The method of claim 15, wherein the forming of the plurality of curved surfaces comprises:
determining the number of curved surfaces constituting the multiple curvature surface;
determining an area of each of the curved surfaces constituting the multiple curvature surface; and
determining a curvature radius of each of the curved surfaces constituting the multiple curvature surface.

20. The method of claim 19, wherein the determining of the number of the curved surfaces comprises determining the number of the curved surfaces such that the number of the curved surfaces is identical to or greater than the number of target object distances set in advance such that an object is focused for each of the target object distances.

21. The method of claim 20, wherein the target object distances include a target close-up shot distance set in advance such that an object located at a close distance is focused, and a target infinite object distance set in advance such that an object located at a distance corresponding to infinity is focused.

22. The method of claim 20, wherein the target object distances further include a target intermediate object distance set in advance such that an object located at a distance between the target close-up shot distance and the target infinite object distance is focused.

23. The method of claim 22, wherein two or more target intermediate object distances are set.

24. The method of claim 19, wherein the determining of the area comprises determining the area of each of the curved surfaces such that the area of each of the curved surfaces are the same.

25. The method of claim 19, wherein the determining of the area comprises determining the area of each of the curved surfaces such that the area of each of the curved surfaces is ±50% of an area of each of the curved surface which is supposed that an area of each of the curved surfaces is same.

26. The method of claim 19, wherein the determining of the area comprises determining the area of each of the curved surfaces such that the area of the curved surface formed on a center of the multiple curvature surface is greater than areas of the other curved surfaces.

27. The method of claim 19, wherein the determining of the curvature radius comprises determining the curvature radius of each of the curved surfaces that corresponds to each target object distance such that an object is focused for each target object distance.

28. The method of claim 19, wherein the determining of the curvature radius comprises determining the curvature radius such that each curved surface formed on the multiple curvature surface constitutes one of a spherical surface and an aspherical surface.

29. The method of claim 15, further comprising:
installing an image sensor to sense an image formed by the lenses; and
installing an image processing unit for recovering the image sensed by the image sensor.

30. The method of claim 29, wherein the image processing unit recovers the image using a PSF (point spread function).
